(19) United States
(12) Patent Application Publication
(10) Pub. No.: US 2003/0065862 A1
(43) Pub. Date: Apr. 3, 2003

(54) Computer system and method for communications between bus devices

(76) Inventor: David C. Wyland, Morgan Hill, CA (US)

Correspondence Address: SCHNECK & SCHNECK, P.O. BOX 2-E, SAN JOSE, CA, 95109-0005, US

(21) Appl. No.: 09/968,467

(22) Filed: Sep. 28, 2001

(51) Int. Cl. G06F 13/38

(52) U.S. Cl. 710/305

(57) ABSTRACT

Disclosed is a computer system and method for communications between devices in the computer system. The computer system comprises a global bus which includes a Transfer Acknowledge (TACK) wire and two Command Reject (CRJ) wires for notifying a master device of different situations after the master device sends a command or data octet (64 bits) to a target device. If the target device receives the octet, it toggles the TACK line. After that, if the target device accepts the command octet, it sends 00 on the two CRJ lines. But if it rejects the octet, it sends 01, 10, or 11 on the two CRJ lines indicating to the master device how long the master should wait before resending the octet. If the command octet is sent to a nonexistent target device, the TACK line does not toggle. The master recognizes this situation and acts accordingly.

### TECHNICAL FIELD

The present invention relates to computer systems and methods for communications between devices in the system over a common system bus, and more particularly to a computer system and method for communications between bus devices in the computer system using an acknowledgment protocol.

### BACKGROUND ART

In digital computer systems having a plurality of devices, such as processor devices, controller devices, communications interface (relay) devices, etc., a medium is employed whereby these devices can transfer data among each other. Typically, the medium employed is a physical data channel known as a bus. The bus is connected to a communication port on each module. Each module is a potential bus master that needs the bus to communicate with other devices. For example, a processor may need data stored in SDRAM memory.

In a uniprocessor system, a typical memory read transaction occurs as follows. The processor (master device) requests for bus use. When the processor is granted bus access, it sends its request for data via the bus to the memory (target device). While waiting for the memory to retrieve the requested data, the processor does not release the bus. This is not a problem because no other device needs the bus anyway and the processor has nothing else to do but wait for the requested data from the memory device. However, in a multiprocessor system, it is an inefficient use of bus time to allow the processor to seize the bus while waiting for its requested data from the memory device. Therefore, split transaction protocol is used to fix this problem. Under split transaction protocol, a read transaction has two phases. In phase one, the processor first requests for bus access. When the processor is granted bus access, it sends its request for data via the bus to the memory device, and then releases the bus so that other devices can use the bus. This completes phase one of the read transaction. In phase two, when the memory device has the requested data ready, it arbitrates for bus access. When the memory device is granted bus access, it sends the requested data via the bus to the requesting processor. This completes phase two of the read transaction.

A write transaction over the bus has only one phase. The master device arbitrates for the bus access. When it is granted the bus access, the master device sends a write command and write data on the bus to the target device (memory) and then releases the bus. This completes the write transaction.

There are several unwanted possibilities in these bus transactions. One unwanted possibility is that the master device sends its request for data to a nonexistent target device, meaning there is no such device at the address contained in the request. The master device should be informed of this situation so that it can respond accordingly. Another unwanted possibility is that the master device sends a command or data to a target device, but the target device is busy, i.e., its command or data buffer is full. Yet another unwanted possibility is that the master device sends a command or data to a target device, but the command or data gets lost. Different prior art computer systems respond differently to these unwanted situations.

U.S. Pat. No. 5,959,995 to Wicki, et al. describes a communication protocol in a multiprocessor system. When the target device receives a packet from a master device, the target device sends an acknowledgment to the master device. The master device resends the packet if it does not receive the acknowledgment in a predetermined time. Under this protocol, if the master device sends a packet to a nonexistent device, it will not receive any acknowledgment. The master device will resend the packet. This wastes the bus bandwidth. Therefore, one object of the present invention is to inform the master device as soon as possible the nonexistence of the target device so that it will not resend the packet of command or data.

U.S. Pat. No. 4,744,023 to Welsch, et al. describes a communication protocol in a multiprocessor system in which each processor of the multiprocessor system has an associated receive buffer and an address buffer. The protocol can be described as follow. A master processor sends a packet to a target processor. If the target processor cannot accept the packet (because its receive buffer is full), the address of the master processor is stored in the address buffer. A negative acknowledge is sent to the master processor. When the receive buffer of the target processor is emptied by the target processor, the target processor sends a notification message to the master processor signaling that the master processor should resend the packet to the target processor. The problem with this protocol is that some bus bandwidth must be used for sending of both negative acknowledge and notification messages. Therefore, another object of the present invention is to inform the master processor of when to resend without using the bus for sending negative acknowledge and notification messages.

### SUMMARY OF THE INVENTION

The computer system and method for communications between devices in the computer system of the present invention achieve the stated object by adding dedicated communication lines to the system bus and using a unique communication protocol between the bus devices. Under this unique communication protocol, whenever a master device sends a command or data octet (8-byte) to a target device, the target device upon receiving the command or data octet toggles the state of a Transfer Acknowledge wire. It does so whether it accepts or rejects the command or data octet. Therefore, if the transfer acknowledgment wire retains its state, the master device knows that it has sent a command or data octet to a nonexistent target device. Moreover, if the target device rejects the command or data octet because its buffer is full, it sends unique signals on two other dedicated Command Reject wires to notify the master device of how long the master device should wait before resending the command or data octet. As the result, the master device knows right away the nonexistence of a target device (if it is the case). Moreover, the timing for resending of commands and data can be calculated so that the traffic caused by resending is minimum.

### BRIEF DESCRIPTION OF THE DRAWINGS

FIG. 1 is a block diagram of a computer system according to the present invention.

FIG. 2 is a schematic circuit diagram of a Command Reject Logic of FIG. 1.

### BEST MODE FOR CARRYING OUT THE INVENTION

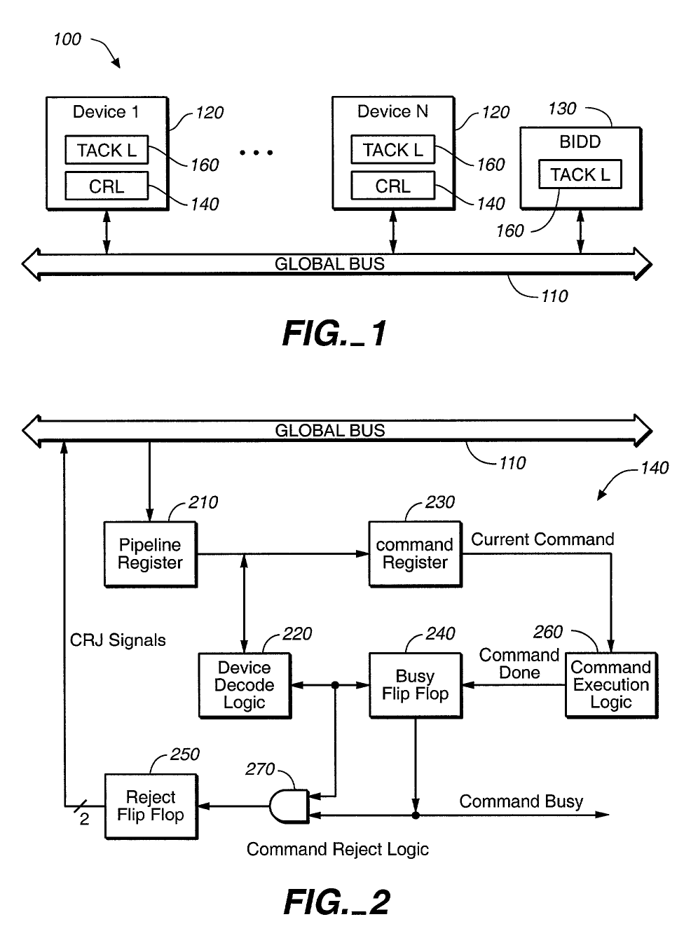

With reference to FIG. 1, a computer system 100 having a global bus 110, a plurality of devices 120 connected to global bus 110 so that devices 120 can communicate with one another via global bus 110, and a Bus Idle Default Device 130. Each device 120 has a Command Reject Logic 140 for generating signals indicating that the device is busy and rejects the incoming command octet (8 bytes), and a Transfer Acknowledge Logic 160 for generating signal indicating that an octet has been received by a target device 120. Each device 120 has a unique 16-bit device number assigned in hardware (hardwired). Each device 120 may also have local memory (not shown) whose location in a global memory map is determined at boot up. Upon reboot, each device 120 and its memory are mapped into a global memory map. Each device 120 has special registers (not shown) for storing pointers pointing to the start and the end of the device's portion in the global memory map. Therefore, when a command (read or write) is sent on global bus 110, except when the device number of the target device 120 is specified on global bus 110, all devices 120 in computer system 100 will decode the global address contained in the command to see if the global address is in its portion of the global memory map. Each device 120 can do this by comparing the global address with the pointers in its special registers.

In a first preferred embodiment of the present invention, global bus 110 comprises a plurality of wires or lines including 64 Data/Address wires. If a data octet (64 bits) is sent on global bus 110, all 64 wires are data. If a command (read or write) octet is sent on global bus 110, 32 of these 64 wires carry the global address of read or write data, and the other 32 wires carry other control signals as will be listed below. In addition, global bus 110 includes 8 Byte Write Enable wires each of which corresponds to a byte of the octet transferred on the 64 Data/Address wires. Next are 3 Word Type wires specifying what data type is currently on the 64 Data/Address wires including: nothing (bus is idle), write data, last write data, read data, and last read data. Next are 16 Target Device wires specifying the Target Device number for the transfer. Next is a Transfer Acknowledge (TACK) wire carrying a signal that toggles whenever a device 120 receives a command or data octet. The TACK signal is described in detail in another application of the same applicants (Cradle Technologies, Inc.) Serial No. 60/128,222, which is incorporated herein. Next are two Command Reject (CRJ) wires carrying two signals that notify the master device, i.e., the device that sent command or data octet, of what happens at the target. They notify if the target device accepts the command or data octet. If the target device rejects the command or data octet, they notify the time the master device 120 should wait before resending the command or data octet to the target device. Next are 2 wires for system reset and bus clock. Next are 2 wires per device: one for receiving bus access request from the device 120 and one for sending bus access grant to the device 120.

For each bus cycle, an octet (64 bits) of command or data may be transferred on the 64 Data/Address wires of global bus 110. If the octet is data, all 64 Data/Address bits are data. If the octet is a command octet, its format is as follows: 32 bits for global address of read or write data, 1 bit for transfer type (0=read, 1=write), 16 bits for device number of the master device, 2 bits for transfer length (1, 2, 4, or more than 4 octets); 2 bits for priority (0=lowest, 3=highest); and the rest of the bits are reserved or other signals.

Each octet transferred on global bus 110 is acknowledged by the target device receiving the octet by activating the Transfer Acknowledge (TACK) wire. This is true for each octet transferred, command or data. TACK signal indicates that the target device 120 has received a command octet or data octet intended for it. It should be noted that receive does not mean accept. After receiving the octet, the target device 120 may either accept or reject it.

When a target device 120 sees an octet on global bus 110, it decodes the 16 Target Device wires of global bus 110 to see if it is the intended target. If it is, the target device 120 is said to have received the octet. Then, the target device 120 activates TACK two clocks after the octet was transferred on global bus 110. The target device 120 activates TACK even if it rejects the command because it is busy. If the command was a write, each of the write data octets that follows the command octet is also acknowledged by the target. Likewise, a master device 120 receiving read data activates TACK for each read octet it receives. TACK signal allows detection when no device has responded to a command octet, which is a bus error. TACK helps detection of this as soon as two bus clocks after the command octet was sent, without having to wait for a bus time out. More than one device 120 can respond with a TACK signal without interference.

TACK has a unique coding. To activate TACK, the receiving device 120 changes the state of TACK line from the previous clock. Note that more than one device 120 can respond with a TACK signal. All receiving devices 120 will drive TACK in the same direction. If no device drives TACK, stray capacitance and bus hold logic will keep the TACK line at its previous level. If no device transfers anything on global bus 110, Bus Idle Default Device 130 will send some dummy data on global bus 110 and also toggle the TACK line for each dummy octet sent.

The two Command Reject (CRJ) wires indicate command reject by the target device 120 and indicate how long the master device 120 should wait before resubmitting the read or write command octet. The wait time is called the back off time. A code of 00 is command accepted. A code of 01 is command reject with minimum back off time. Codes 10 and 11 indicate longer back off times. Command reject occurs when the target is busy servicing a prior command and then a new command comes in. This can happen when two master devices 120 try to send command to the same target in quick succession.

The normal response to command reject is to resend the command octet after a waiting period called the back off time. If all master devices 120 get the same back off time, the commands will be resent in the order they were rejected by the target device. The best back off time is a function of the response time of the target device. The two CRJ wires indicate either command acceptance (00) or one of three back off time codes, as supplied by the target device. The master device 120 should wait for 16, 32 or 64 GLOBAL BUS clocks for codes of 01, 10 or 11, respectively, before resending the command.

If a command octet is sent to a nonexistent target device, TACK signal will not toggle and the two CRJ lines will be undefined A processor may want to test for memory by writing and reading in the memory space. If no memory is there, the TACK signal does not toggle.

The two CRJ signals can be used to indicate a hardware condition. For instance, a hardware FIFO could be useful for task list management. In this case, new task pointers are written to the hardware FIFO in a global area, and each active processor would get tasks by reading from the FIFO. If the FIFO is full of tasks and a processor attempts to write a task pointer to the FIFO, a command reject occurs. The CRJ signals can be used to interrupt the processor that was writing the task pointer to the FIFO. Likewise, if the FIFO is empty and a processor attempts to read the FIFO, a command reject occurs. This could be used to interrupt the reading processor.

When global bus 110 is idle, no active device is selected to drive the bus. A bus arbiter selects a default device, the Bus Idle Default Device (BIDD) 130, to drive the bus. Otherwise, the bus lines would float, potentially causing noise and errors. BIDD 130 drives the bus signals to a safe default state. It holds the address/data lines at their previous values (for low power consumption). It drives the 8 byte enable wires to inactive, the target device number to all ones, and the two CRJ lines to inactive. BIDD 130 also responds with a TACK response to broadcast writes.

In the first preferred embodiment of the present invention, BIDD 130 is used to respond to the situations where a master device 120 sends a read command octet to a nonexistent target device. BIDD 130 has a lack-of-TACK recognition logic (not shown) that detects the lack of TACK signal. BIDD 130 then sends dummy data to the waiting master device 120 that sent the command octet. At the same time, BIDD pulls all the 8 Byte Write Enable wires of GLOBAL BUS 110 down to zero to notify the master device 120 that the data on 64 Data/Address wires is dummy. This mechanism saves chip area and reduces costs when compared with providing a lack-of-TACK recognition logic at every device. Here, just one lack-of-TACK recognition logic in BIDD 130 is sufficient.

In a write by a master device 120 to a target device, the master initiates the write by sending a write command octet followed by one to four write data octets to global bus 110. The write command octet is broadcast to all devices 120 (including the master device). It is broadcast because the master does not know which device will respond in view of the address contained in the write command octet. The command octet contains a 32-bit global address for the write as well as the transfer type (write) and transfer length (1 to 4 octets). It also contains the master's device number, but this number is not used in write operations. All devices 120 in computer system 100 “see” the write command octet and write data octets on GLOBAL BUS 110. Each device 120 compares the 32-bit global address in the write command octet against its own global address, i.e., its portion of the global memory map specified by the pointers in its special registers. If there is a match, the device, now called a target device, is said to have received the command octet and it toggles the TACK line. If the device 120 is not busy, it accepts the write data octets and clocks them out of its write FIFO. The target also toggles TACK line for each of these write data octets. The device 120 also sends a code of 00 on the two CRJ lines. This terminates the write operation. If there is a match but the target device 120 is busy with a previous command, it sends a command reject on the two CRJ wires. It also toggles the TACK line in this situation. If there is no match, the device 120 ignores the command. It neither toggles the TACK line nor drives the two CRJ lines. Note that all writes are broadcast. Meaning that the target device number on the 16 wires of global bus 110 are all zero. Normally only the intended target will accept the broadcast write data; the other devices 120 will discard it. However, it is possible to broadcast write data to more than one target if the targets are designed to decode a range of broadcast addresses.

In a read by a master device 120 from a target device, the master initiates the read by sending a read command octet to global bus 110. The read command octet is broadcast to all devices 120 (including the master device). The read command octet is broadcast because the master does not know which Global Bus device 120 will respond in view of the 32-bit address contained in the read command octet. The read command octet contains the 32-bit global address of the read data in some local memory or system memory as well as the transfer type (read) and transfer length (1-4 octets). The read command octet also contains the master device's device number, which the target device 120 will use for sending back read data. When the master has sent the read command octet, it arms its read FIFO to receive the read data at a later time. The master normally stalls and waits for the target to send it the read data, completing the read transaction. Each device 120 in computer system 100 “sees” the read command octet on global bus 110. Each device 120 compares the 32-bit global address in the read command octet against its own global address, i.e., its portion of the global memory map specified by the pointers in its special registers. If there is a match, meaning it is the intended target device, the device, now called a target device, is said to have received the command octet and it toggles the TACK line. If the device 120 is not busy, it accepts the write data octets and clocks them out of its write FIFO. The device 120 also sends a code of 00 on the two CRJ lines. The target device 120 then gets the requested data and sends the data via the global bus 110 to the master that requested the read data by using the master device's number contained in the read command octet. When the master device 120 receives the read data, it toggles TACK line for each data octet it receives. This terminates the read operation. If there is a match but the target device 120 is busy with a previous command, it sends a command reject to the bus (on the two CRJ lines of global bus 110). If there is no match, the target ignores the command. Note that the only valid way that data can be sent to a waiting read FIFO in a master is in response to a previously sent read command. Only command octets, not data octets, contain the device number of the master that sent the command, and this device number is hard wired into the master device 120 sending the read command. There is no valid way that some other device 120 could send data to an open master read FIFO, causing improper completion of an open read command.

Each master device 120 on the global bus 110 can have only one outstanding transfer in progress at any one time. This is called self throttling. This provides automatic control of the transfer bandwidth between the master(s) and a target. For read transfers, after sending the read command octet, the master waits for read data to be returned. For write transfers, after sending the write command octet and data octets, the master checks the TACK line and two CRJ lines. If TACK line does not toggle, the master should move on because the intended target is nonexistent. If TACK line toggles, and if the two CRJ lines are 00, the master should move on because the target has accepted the command and data octets. If TACK line toggles, and if the two CRJ lines are not 00, the master device 120 should wait and resend the command and data octets until they are accepted. The wait time depends on the code on the two CRJ lines.

Global bus 110 is faster than its target devices 120. If the target device 120 is slow or if more than one master attempts to transfer data to the target at one time, the target will not be able to accept the command. In this case, it issues a command reject.

With reference to FIG. 2, each device 120 (FIG. 1) in COMPUTER SYSTEM 100 has a Command Reject Logic 140 comprising a Pipeline Register 210, a Command Register 230, a Device Decode Logic 220, a Busy Flip Flop 240, a Reject Flip Flop 250, and a Command Execution Logic 260 coupled to one another as shown. Pipeline Register 210 is coupled to GLOBAL BUS 110 and buffers the command and data octets and other signals on GLOBAL BUS 110. Device Decode Logic 220 is coupled to Pipeline Register 210 to monitor the output of Pipeline Register 210 to detect if a command is present. If so, Device Decode Logic 220 compares the global address contained in the command with the global address of the device 120 to which it belongs. Device Decode Logic 220 also detects the 16-bit Target Device Number lines of global bus 110 to see if the command octet is for the device 120 to which it belongs. There are two cases where the command octet is intended for the device. The first case is when the 16-bit Target Device Number represents the device number of the device. The second case is when the global address contained in the command matches the device's portion in the global memory map. In both cases, if Busy Flip Flop 240 is not set, meaning the device 120 is not busy, Device Decode Logic 220 loads the command octet from Pipeline Register 210 into Command Register 230 and sets the Busy Flip Flop 240. If the Busy Flip Flop 240 is set, meaning the device 120 is busy, Device Decode Logic 220 sets the Reject Flip Flop 250 via an AND gate 270 that makes sure that Reject Flip Flop 250 is set only when (a) the current command is not serviced, i.e., Busy Flip Flop 240 is set, and (b) another command intended for the device 120 comes in. Reject Flip Flop 250 when set drives the two CRJ signals on GLOBAL BUS 110. It also inhibits loading Command Register 230 with a new command until the current command has completed. A Command Execution Logic 260 indicates command completion by sending a Command Done signal resetting the Busy Flip Flop 240. Busy Flip Flop 240 when reset will allows Device Decode Logic 220 to load another command (if any) into Command Register 230 and then to Command Execution Logic 260.

1. A computer system comprising:
a global bus including a plurality of dedicated lines for indicating the status of the operations on said global bus; and
a plurality of devices having connection to said global bus;
wherein when a master device of said plurality of devices sends a data unit to a target device of said plurality of devices, said dedicated lines indicates whether said target device exists, whether said target device accepts the data unit, and how long said master device should wait before resending the data unit if said target device rejects the data unit.

2. The computer system of claim 1 wherein each said device comprises:
a transfer acknowledge logic for generating a transfer acknowledge signal on a first dedicated line of said dedicated lines indicating whether said target device exists; and
a command reject logic for generating two command reject signals on a second and third dedicated lines of said dedicated lines indicating whether said target device accepts the data unit and how long said master device should wait before resending the data unit if said target device rejects the data unit.

3. The computer system of claim 2 further comprising a bus idle default device for providing dummy data to said master device if said master device sends an data unit to a nonexistent target device.

4. The computer system of claim 3 wherein said transfer acknowledge signal on said first dedicated line toggles when the data unit is received by a target device, but does not toggle when said target device is nonexistent.

5. The computer system of claim 4 wherein said two command reject signals on said second and third dedicated lines have a combination of 00 indicating said data unit has been received by a target device, combinations of 01, 10, and 11 indicating that said master device should wait a short, intermediate, and long period of time, respectively, before resending the data unit because said data unit has been rejected by said target device.

6. The computer system of claim 2 wherein said transfer acknowledge signal on said first dedicated line toggles when the data unit is received by a target device, but does not toggle when said target device is nonexistent.

7. The computer system of claim 6 wherein said two command reject signals on said second and third dedicated lines have a combination of 00 indicating said data unit has been received by a target device, and combinations of 01, 10, and 11 indicating that said master device should wait for a short, intermediate, and long period of time, respectively, before resending the data unit because said data unit has been rejected by said target device.

8. The computer system of claim 2 wherein said two command reject signals on said second and third dedicated lines have a combination of 00 indicating said data unit has been received by a target device, combinations of 01, 10, and 11 indicating that said master device should wait a short, intermediate, and long period of time, respectively, before resending the data unit because said data unit has been rejected by said target device.

9. A method of communication between devices in a computer system having a global bus connecting to each said device, said method comprising the steps of:
providing dedicated lines as part of said global bus, said dedicated lines connecting to each said device;
using said global bus as a medium for a master device of said devices to send a data unit to a target device of said devices; and
using said dedicated lines to indicate to said master device whether said target device is existent, whether said target device accepts or rejects the data unit, and how long said master device should wait before resending said data unit to said target device if said target device rejects the data unit.

10. The method of claim 9 wherein said step of using said dedicated lines comprises the steps of:
providing a transfer acknowledge logic for each said device, said transfer acknowledge logic being connected to a first dedicated line of said dedicated lines; and
using said transfer acknowledge logic of said target device to indicate to said master device via said first dedicated line whether said target device is existent.

11. The method of claim 10 wherein said step of using said transfer acknowledge logic of said target device comprises the steps of toggling a transfer acknowledge signal on said first dedicated line to indicate to said master device that said target device is existent.

12. The method of claim 11 wherein said step of using said dedicated lines further comprises the steps of:
providing a command reject logic for each said device, said command reject logic being connected to second and third dedicated lines of said dedicated lines; and
using said command reject logic of said target device to indicate to said master device via said second and third dedicated lines whether said target device accepts or rejects the data unit, and how long said master device should wait before resending said data unit to said target device if said target device rejects the data unit.

13. The method of claim 12 wherein said step of using said command reject logic of said target device comprises the steps of:
generating on said second and third dedicated lines a command reject signals of 00 to indicate to said master device that said target device accepts the data unit sent by said master device; and
generating on said second and third dedicated lines a command reject signals of 01, 10, or 11 to indicate to said master device that said master device should wait for a short, intermediate, or long period of time, respectively, before resending the data unit to said target device because said data unit has been rejected by said target device.

14. The method of claim 13 further comprising the steps of:
providing a bus idle default device being connected to said global bus; and
using said bus idle default device to supply dummy data to said master device via said global bus whenever said dedicated lines indicate that said target device is nonexistent.

15. The method of claim 10 wherein said step of using said dedicated lines further comprises the steps of:
providing a command reject logic for each said device, said command reject logic being connected to second and third dedicated lines of said dedicated lines; and
using said command reject logic of said target device to indicate to said master device via said second and third dedicated lines whether said target device accepts or rejects the data unit, and how long said master device should wait before resending said data unit to said target device if said target device rejects the data unit.

16. The method of claim 15 wherein said step of using said command reject logic of said target device comprises the steps of:
generating on said second and third dedicated lines a command reject signals of 00 to indicate to said master device that said target device accepts the data unit sent by said master device; and
generating on said second and third dedicated lines a command reject signals of 01, 10, or 11 to indicate to said master device that said master device should wait for a short, intermediate, or long period of time, respectively, before resending the data unit to said target device because said data unit has been rejected by said target device.

17. The method of claim 16 further comprising the steps of:
providing a bus idle default device being connected to said global bus; and
using said bus idle default device to supply dummy data to said master device via said global bus whenever said dedicated lines indicate that said target device is nonexistent.

18. The method of claim 15 further comprising the steps of:
providing a bus idle default device being connected to said global bus; and
using said bus idle default device to supply dummy data to said master device via said global bus whenever said dedicated lines indicate that said target device is nonexistent.

19. The method of claim 9 wherein said step of using said dedicated lines further comprises the steps of:
providing a command reject logic for each said device, said command reject logic being connected to second and third dedicated lines of said dedicated lines; and
using said command reject logic of said target device to indicate to said master device via said second and third dedicated lines whether said target device accepts or rejects the data unit, and how long said master device should wait before resending said data unit to said target device if said target device rejects the data unit.

20. The method of claim 9 further comprising the steps of:
providing a bus idle default device being connected to said global bus; and
using said bus idle default device to supply dummy data to said master device via said global bus whenever said dedicated lines indicate that said target device is nonexistent.
